(19) United States
(12) Patent Application Publication
(10) Pub. No.: US 2007/0108850 A1
(43) Pub. Date: May 17, 2007

(54) LINEAR ELECTRICAL MACHINE FOR ELECTRIC POWER GENERATION OR MOTIVE DRIVE

(75) Inventor: Allan Chertok, Cambridge, MA (US)

Correspondence Address: LOWRIE, LANDO & ANASTASI, RIVERFRONT OFFICE, ONE MAIN STREET, ELEVENTH FLOOR, CAMBRIDGE, MA, 02142, US

(73) Assignee: TIAX LLC, Cambridge, MA (US)

(21) Appl. No.: 11/561,215

(22) Filed: Nov. 17, 2006

Related U.S. Application Data
(60) Provisional application No. 60/737,512, filed on Nov. 17, 2005.

(51) Int. Cl. H02K 41/00; H02K 35/00

(52) U.S. Cl. 310/15; 310/14

(57) ABSTRACT

A linear electrical machine may function as an alternator or a motor. Three annular magnets may be provided that move relative to a core. The magnets may all have a different magnetic orientation. Two magnets may have a north pole oriented in a direction parallel to an axis along which the magnets move relative to the core. Another magnet may have a north pole oriented in a direction perpendicular to the axis. The core may include a plurality of ferromagnetic core elements; and a support structure composed of a composite material defining plural spaces, each for receiving one of the plurality of core elements. The core may further include a core shield disposed on the support structure substantially following a perimeter of the support structure defining an opening through which a reciprocating element can pass. Furthermore, the magnets may be supported in a reciprocating element having a low reluctance ferromagnetic frame there being a clearance gap between the machine core and the reciprocating element, the frame having a thicker section adjacent the gap, so as to desirably increase magnet flux linkage with an armature coil.

### RELATED APPLICATION

The present application is a non-provisional application claiming the benefit under 35 U.S.C. § 119(e) of U.S. Provisional application Ser. No. 60/737,512, filed on Nov. 17, 2005. The present application is also related to U.S. patent application Ser. No. 10/612,723, filed on Jul. 2, 2003, and now issued as U.S. Pat. No. 6,914,351, having at least one common inventor, and incorporated herein by reference.

### BACKGROUND OF INVENTION

1. Field of Invention

The invention relates to improvements to a linear electrical machine for electric power generation or motive drive.

2. Discussion of Related Art

Quiet and efficient electric power generation can be important in a variety of applications. For example, boats and other spaces having power generation systems in close proximity to people have a need for quiet operation. As a result, turbines, internal combustion engines and other power sources are often far too noisy for use in such applications. Free piston Stirling engines, however, operate fairly quietly and have been used to drive linear electrical machines also referred to as linear alternators to generate electric power. (The term “alternator” is used herein to generically refer to any type of electric power generation device, whether producing alternating current, direct current, or other forms of electric power. Except for the case of the automotive “alternator” which has a built in rectifier to provide 12 volt DC output, the term “alternator” would otherwise be understood to be an electrical machine which produces AC power.) These power generation systems are typically best suited by a linear alternator that can operate efficiently within the range of motion of a piston in the free piston Stirling engine (FPSE) that drives the alternator.

### SUMMARY OF INVENTION

In one aspect of the invention, a hybrid core for an electric machine is provided that includes a plurality of ferromagnetic core elements; and a support structure composed of a composite material defining plural spaces, each for receiving one of the plurality of core elements.

In another aspect of the invention, a ferromagnetic shell having a first cavity defined therein for receiving a coil, and having a second cavity defined therein by a perimeter and through which a moving element can pass; and a core shield disposed on the shell substantially following the perimeter of the second cavity and displaced on the shell away from the second cavity.

In yet another aspect of the invention, a reciprocating element including a low reluctance ferromagnetic frame supporting at least one magnet for reciprocation within a cavity formed in a machine core, there being a clearance gap between the machine core and the reciprocating element, the frame having a thicker section adjacent the gap, so as to desirably increase magnet flux linkage with an armature coil.

Numerous variations of the invention are contemplated. The ferromagnetic core elements may each include a core lamination stack including plural layers of a high permeability soft ferromagnetic sheet material. The support structure may further include a shell defining the plural spaces and further defining together with the core elements a cavity for receiving a coil, or the support structure may further include a plurality of generally wedge-shaped segments defining the plural spaces between faces of adjacent core elements and further defining together with the core elements a cavity for receiving a coil. The composite material of which the support structure is composed may be a high permeability soft ferromagnetic material or may be a filled resin having high thermal conductivity and strength. In the case of a filled resin, the composite material may be a glass-filled nylon or glass-filled epoxy, for example.

Combinations of the above inventions, aspects and variations are also possible. For example, the hybrid core and its variations may also include a core shield disposed on the support structure substantially following a perimeter of the support structure defining an opening through which a reciprocating element can pass. Also, the hybrid core and its variations may also further include a reciprocating element passing through the opening ferromagnetic frame supporting at least one magnet, there being a clearance gap between the machine core and the reciprocating element, the frame using a thicker section adjacent to the gap, so as to desirably increase magnetic flux linkage with an armature coil supported within a cavity defined by the support structure.

These and other aspects of the invention will be apparent and/or obvious from the following description.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a schematic view of a linear electrical machine in accordance with the invention coupled to an illustrative power source;

FIG. 2 is a cross-sectional view of the linear electrical machine shown in FIG. 1;

FIG. 3 shows exemplary magnetic field lines in one illustrative embodiment;

FIG. 4 is a schematic view of a two-part core;

FIG. 5 is a schematic view of a core having an array of lamination packs forming a core in another illustrative embodiment;

FIG. 6 shows a movable element having three annular magnets mounted to a back iron element;

FIG. 7 shows a movable element having annular magnets formed from magnet segments;

FIG. 8 shows a schematic view of another linear electrical machine in accordance with the invention;

FIG. 9 is a cross-sectional view of the linear electrical machine shown in FIG. 8;

FIG. 10 is a perspective view of a composite core shell;

FIG. 11 is a perspective view of a core lamination stack suitable for use with the shell of FIG. 10;

FIG. 12 is a perspective view of a hybrid core including the composite core shell of FIG. 10 and plural lamination stacks of FIG. 11;

FIG. 13 is a cross-sectional view of a motor core and movable element showing a core shield and ring; and

FIG. 14 is a perspective view of an alternate hybrid core embodiment including wedge-shaped composite elements, plural lamination stacks and core shield features.

### DETAILED DESCRIPTION

Aspects of the invention are not limited to the details of construction and arrangement of components set forth in the following description or illustrative embodiments. That is, aspects of the invention are capable of being practiced or of being carried out in various ways. For example, various illustrative embodiments are described below in connection with an electric power generator. However, aspects of the invention may be used in a linear motor (e.g., a device that can output a linear mechanical motion in response to an electric signal provided to the device). Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

In one aspect of the invention, a linear electrical machine includes a movable permanent magnet “field” element that moves along a longitudinal axis in a central opening of an armature coil embedded in a ferromagnetic armature core, these latter components comprising an armature unit. The core provides a relatively low reluctance path for magnetic flux, thus enhancing the coil flux linkage produced by the field element. When the linear electrical machine serves as an alternator, electrical power is produced as a consequence of field element motion provided by a free piston Stirling engine or other prime mover which motion induces an armature coil voltage proportional to the temporal rate of change of the coil flux linkage developed by the permanent magnets. Electrical power is produced when this induced voltage drives a current through an electrical load. The interaction of the magnetic flux developed by the coil current and the field element produces the reaction force that must be overcome by the free piston Stirling engine or other prime mover. The instantaneous mechanical input power is given by the product of instantaneous values of reaction thrust and field element linear velocity.

When the linear electrical machine serves as a motor, mechanical power is produced as a consequence of thrust developed by the field element and the resulting motion of a mechanical load driven by it. The thrust developed by the field element is proportional to the spatial rate of change of the coil flux linkage developed by the permanent magnets and a coil current driven by an electrical power source. The voltage induced in the coil by the moving field element must be overcome by the electrical power source so that it may drive the coil current. The instantaneous electrical input power is given by the product of instantaneous values of coil terminal voltage and coil current.

In one aspect of the invention, the movable element may include three magnets that all have a different magnetic orientation. For example, a first magnet may have a north pole oriented in a first direction parallel to the longitudinal axis, a second magnet may have a north pole oriented in a second direction perpendicular to the longitudinal axis, and a third magnet may have a north pole oriented in a third direction parallel to the longitudinal axis that is different from the first direction. This arrangement may provide for a concentrated magnetic flux generated by the movable element that maximizes power generation in the coil while minimizing stray magnetic fields and ferromagnetic magnetic circuit material (also known as “back iron”) needed to carry the magnetic flux.

Such an arrangement may also be effective in minimizing the residual unbalanced transverse force exerted on the movable field element (a force that urges the movable element to deviate from a particular path along the longitudinal axis). Residual unbalanced transverse force may arise due to mechanical eccentricity of the movable field element relative to the central opening in the core such that the transverse force of attraction between the moving magnet element and the core is not uniform about its circumference due to non-uniformity of the air gap reluctance between these elements. Linear electric machines in accordance with one aspect of the invention employ magnets having a radial thickness dimension larger than prior art electrical machines of comparable thrust and power ratings. As the permeability of the magnet material is very low (nearly that of free space), the effective air gap between the moving field element and the central opening of the core is much greater than that of the mechanical clearance gap alone. The magnetic circuit reluctance of this effective air gap may serve to reduce the transverse attractive radial force exerted on the moving field element and hence any residual unbalance force due to mechanical eccentricity. This suppression of unbalanced radial force is attained by some embodiments of the present invention to a greater extent than prior art linear electric machines which employ thinner magnet components and a thicker back iron element, which configuration typically offers less air gap reluctance.

In another aspect of the invention, the movable element may include a back iron element of soft magnetic (magnetizable) material that provides a path for magnetic flux driven by the magnetic field created by the magnets in the movable element. The soft magnetic material may serve to better concentrate the magnetic flux and prevent stray magnetic fields, thereby increasing the efficiency of the device.

In another aspect of the invention, three magnets provided on a movable element may have magnetic orientations that are all different from each other and arranged so that the magnetic orientation of adjacent magnets are within 90 degrees of each other. The magnets may be annular magnets that are made as one piece, or may be annular magnets that are made from an assembly of magnets.

In another aspect of the invention, three magnets provided in a movable element may have magnetic orientations arranged so that all magnets having a north pole oriented in a direction perpendicular to the longitudinal axis have the north pole arranged radially inward.

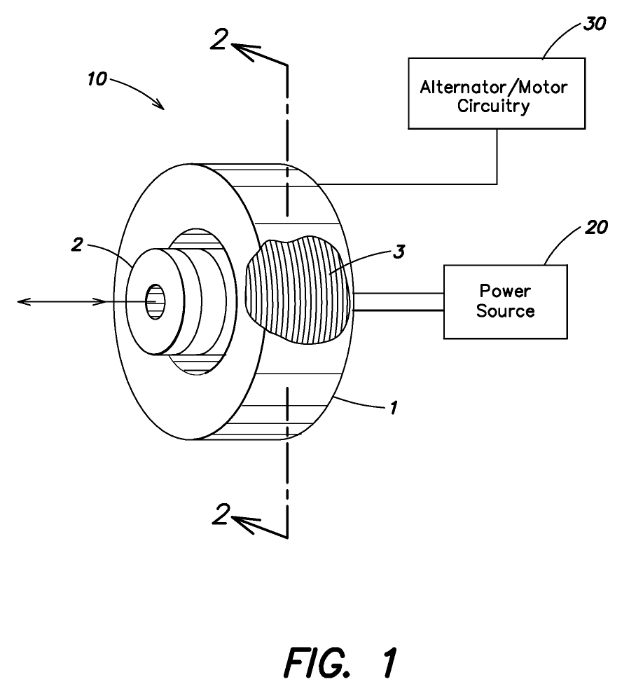

FIG. 1 shows a linear electrical machine 10 that incorporates various aspects of the invention. In this illustrative embodiment, the linear electrical machine 10 functions to generate electric power when the movable element 2 is moved linearly by a power source 20 relative to a coil 3 embedded in a core 1. The power source 20 may be any suitable device that causes the movable element 2 to move, such as a free piston Stirling engine, or other linear motion prime mover. Of course, the power source 20 may be replaced with another device that is driven by the linear electrical machine 10, e.g., when the linear electrical machine 10 acts as a linear motor. For example, electric drive signals may be provided to the coil 3 embedded in the core 1 so that a varying magnetic field is generated, causing the movable element 2 to reciprocate relative to the core 1. This motion may perform work, such as driving a compressor, etc. In short, the linear electrical machine 10 may operate as an alternator or as a motor.

The linear electrical machine 10 may be linked to an electrical load which may in one instance be suitable electronic circuitry 30 to receive electric current driven by the coil 3 as the movable element 2 moves relative to the core 1. As will be understood, such electronic circuitry can include any suitable components to convert the alternating current power provided by the electrical machine to any suitable form of electric power, e.g., AC, DC or other electric current forms. The electrical machine, again serving as an alternator, may also be connected to a load which is directly compatible with the frequency and amplitude of the alternating voltage it develops and requires no separate electronic power conversion means. Alternatively, the electrical machine serving as an alternator may also be connected to a power system of much larger capacity such as a utility power grid and will supply power to that system.

If the linear electrical machine 10 serves as a linear motor, the electronic circuitry 30 may include suitable control circuitry or other components, such as switches, relays, mechanical linkages, etc., to control the operation of the linear motor. Such circuitry and other components are well known in the art and additional details are not provided herein. Alternatively the electrical machine may be operated as a motor by connection to a non-electronic power source such as a utility power grid provided first that oscillation of the motor at the power system frequency is acceptable for the application and second that the coil is designed to provide an appropriate back emf incrementally lower than the system voltage such that the current drawn from the system is that required to develop the rated mechanical thrust.

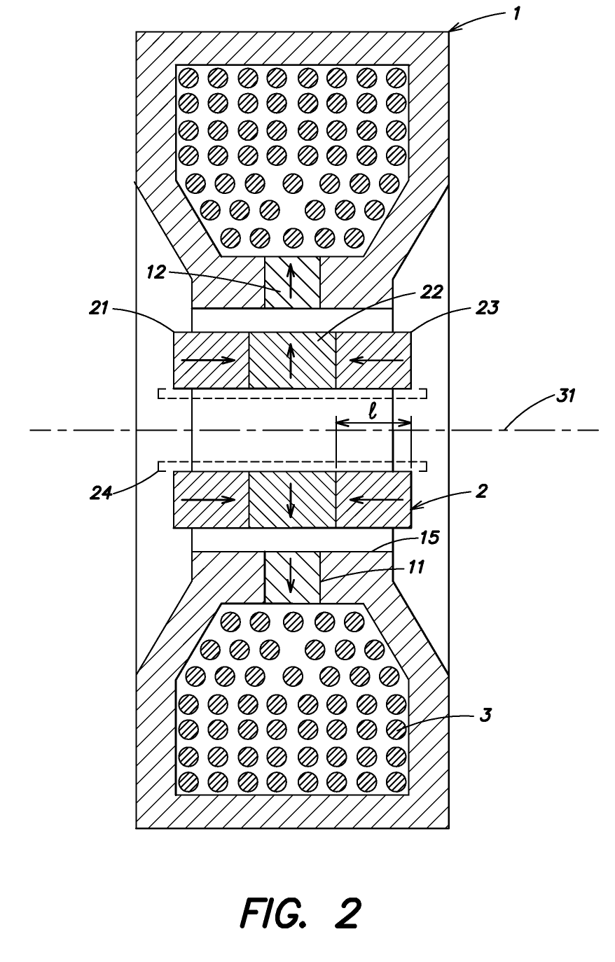

FIG. 2 shows a cross-sectional view of the linear electrical machine 10 along the line 2-2 in FIG. 1. In this illustrative embodiment, the core 1 has an approximately annular or toroidal shape with a central opening 15 in which the movable magnet field element 2 is positioned, although the core 1 may take any other suitable shape. The core 1 provides a relatively low reluctance path for a magnetic flux that may be formed around the coil 3 positioned at least partially in the core 1. As the magnetic flux changes in the core 1 (e.g., as the movable element 2 moves), a voltage will be induced in the coil 3 which can serve to drive an electric current through an external electrical load connected to the coil terminals (not shown) The coil 3 may include multiple wraps of conductive wire, such as copper wire, in which the induced current may flow. Alternately, a current flow in the coil 3 may produce a changing magnetic flux in the core 1 that causes the movable element 2 to be driven along the longitudinal axis 31.

One aspect of the invention illustrated in FIG. 2 is that the movable element 2 includes three magnets 21, 22 and 23 that all have a different magnetic orientation. In this illustrative embodiment, the three magnets 21, 22 and 23 are permanent magnets are hollow and have an annular shape, although the magnets may have any suitable polygonal cross-sectional shape. A spring magnet 12, discussed below, may also have a generally annular shape. Each of the annular magnets preferably has a ratio of inside diameter to outside diameter greater than 0.63, in order to facilitate uniform radially outward magnetization of the unmagnetized material of magnets 22 and 12. A ratio of about 0.7-0.75 is presently preferred.

The first magnet 21 has a north pole oriented in a first direction parallel to the longitudinal axis 31. The second magnet 22 has a north pole oriented in a second direction perpendicular to the longitudinal axis (in this case the north pole is oriented radially outward). The third magnet 23 has a north pole oriented in a third direction parallel to the longitudinal axis 31 opposite the first direction. This arrangement efficiently uses the magnetic fields generated by the magnets so that a focused flux is created near the core 1 and a relatively high flux can be induced in the core 1 for a relatively small amount (by mass or volume) of magnet material. In particular, this arrangement of the magnets produces a magnetic flux that is concentrated on a side nearest the core 1, and produces minimal flux on the side opposite the core 1, e.g., inside the movable element 2. Other orientations are possible for the magnets, such as having the first and third magnets 21 and 23 oriented toward the second magnet, but at an angle to the longitudinal axis 31. Similarly, the north pole of the second magnet 22 need not be strictly perpendicular to the longitudinal axis 31, but may be at some other suitable angle relative to the longitudinal axis 31. The second magnet 22 may also be formed from two or more magnets, e.g., two adjacent annular magnets, that each have a magnetic orientation transverse to the longitudinal axis 31 and together operate as a single magnet having a magnetic orientation perpendicular (or otherwise suitably oriented) to the axis 31.

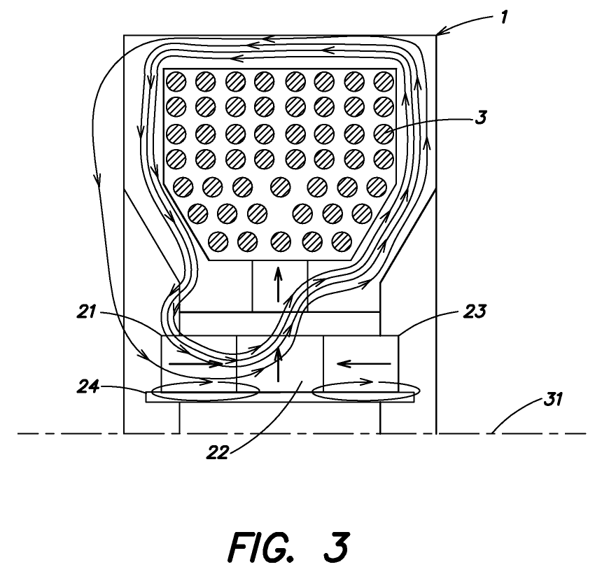

FIG. 3 shows an exemplary set of magnetic flux lines that may be created as the movable element 2 moves along the longitudinal axis. It should be understood that the field lines shown in FIG. 3 is not a complete set of field lines, but rather only selected field lines are shown to help simplify explanation of the operation of the magnets 21, 22 and 23 in the movable element 2. It should also be understood that in FIG. 3 it is assumed that coil current is flowing out of the cross-section indicated). In this example, as the movable element 2 moves to the right along the longitudinal axis 31, a majority of the magnetic flux created by the magnets 21, 22 and 23 exits the second magnet 22, crosses the gap between the movable element 2 and the core 1, enters the core 1 and generally flows counterclockwise around the core 1. The core flux produced by coil current (also known as “armature reaction”) augments the core flux component due to the field magnet element on the left face of the core while diminishing it on the other, thus giving rise to the asymmetrical distribution of core flux depicted in FIG. 3. After traveling around the core 1, the field lines again cross the gap between the core 1 and the movable element 2 and enter the first magnet 21. As will be understood, movement of the movable element 2 varies the flux in the core 1 linking the coil 3, thereby inducing a voltage proportional to the temporal rate of change of this flux linkage which may drive a current flow in the coil 3 and an external electrical load. For example, as the movable element 2 moves to the left (not shown in FIG. 3), the magnetic flux flowing in a counterclockwise direction will decrease until the flux begins to flow in a clockwise direction producing a temporal rate of change of coil flux linkage and induced voltage of opposite sign to that obtained in the case of field element motion to the right.

This basic flux reversal is common in many linear alternators, but the arrangement of the magnetic orientations of the magnets 21, 22 and 23 serves to better focus the flux, prevent stray magnetic fields that do not contribute to flux flowing in the core 1, and therefore improves either the performance of the linear electrical machine or enables a smaller, lighter and less costly construction for a given performance requirement. For example, the better focused flux means that less magnet material is needed to produce an efficient linear electrical machine. In one embodiment, the large effective air gap of the radially thick magnet structure reduces the variability of magnetic circuit reluctance due to residual eccentricity of the moving field magnet element with respect to the core and hence undesired unbalanced transverse force acting on this element which would tend to urge the movable element away from reciprocation along the longitudinal axis 31. As a result, devices that help keep the movable field magnet element 2 moving along a desired path, such as bearings, guideways, etc., will develop smaller undesired frictional losses. Alternatively, reduced transverse loading of such bearings or guideways may permit use of self-lubricating materials, thus avoiding the complexity and expense of lubrication mechanisms and maintenance. In addition, such an arrangement may enable applications which cannot accommodate lubricant contamination, as is the case when a linear electrical machine is integrated within the pressure vessel of a free piston Stirling engine.

Another aspect of the invention illustrated in FIG. 2 is that a back iron element of soft magnetic (magnetizable) material 24 may be provided inside the annular magnets. Although the back iron or other soft magnetic material 24 is optional, it may provide a low reluctance path for flux driven by the magnetic field generated by the magnets. Thus, the back iron may improve the efficiency or power capability of the linear electrical machine by reducing stray magnetic fields and appropriately directing the magnetic flux in a desired way. Because of the focused magnetic field generated by the arrangement of magnets 21, 22 and 23 results in most of the magnetic flux being directed toward the core 1, the back iron 24 may carry little magnetic flux and have a minimal thickness to function effectively. The reduced weight of the back iron 24 may reduce the mass of the movable element 2, thereby improving efficiency or power capability of the linear electrical machine 10 and the associated mechanical apparatus. For example in the case of a linear electrical machine driven by a free piston Stirling engine, a reduction in the moving mass may permit operation of the engine power piston and the alternator moving field element at a higher frequency, thus increasing the power generation capacity of the engine-alternator system in almost direct proportion to the increase of allowable operating frequency. The back iron may also physically support the magnets and connect the movable element to the power source 20 or other device.

Another aspect of the invention illustrated in FIG. 2 is that the magnets 21, 22 and 23 may have a length l along the longitudinal axis 31 that is greater than a maximum left or right displacement of the movable element 2. Said another way, the length l for the magnets 21, 22 and 23 may be greater than ½ the total stroke length of the movable element 2. For example, the magnets 21, 22, and 23 may have a length l that is approximately 10 mm and the movable element 2 may have a maximum displacement along the longitudinal axis 31 of +/−8 mm. Limiting the stroke of the movable element 2 to less than two times the length l of the magnets, or conversely selecting a length l greater than the maximum left/right displacement of the movable element, may provide improved control over how the magnetic flux changes as the movable element reciprocates and for example, in the case of an alternator application, reduce the variation of the electrical machine instantaneous induced voltage/field velocity ratio over the range of operational displacement. Therefore, the linear electrical machine may be made to operate consistently within a set of design parameters.

Another aspect of the invention illustrated in FIG. 2 is that a magnet is provided apart from the movable element to urge the movable element to suitably align the magnets with the coil-core assembly. In this illustrative embodiment, the core 1 includes a spring magnet 12 that is located in a gap 11 in the core 1. The spring magnet 12 may provide a spring-like force that urges the movable element 2 to move approximately to the position shown in FIG. 2. That is, the spring magnet 12 has its magnetic field oriented so that if the movable element 2 is moved from a rest position shown in FIG. 2, the spring magnet 12 causes a force to be created that urges the magnetic field of the second magnet 22, augmented by that of side magnets 21 and 23, to align with the magnetic field of the spring magnet 12. Therefore, any force that moves the movable element 2 left or right from the position shown in FIG. 2 will be opposed by a force that urges the magnetic fields of the spring magnet 12 and the second magnet 22 to align. Other arrangements for the spring magnet 12 may be used to provide the desired biasing of the movable element 2, such as placing two magnets on opposite sides of the core 1 near the first and third magnets 21 and 23. The spring magnet 12 may make start up of the linear electrical machine 10 and associated driving or driven apparatus easier since the movable element may tend to be in a known rest position when the linear electrical machine is inactive. For example, if the spring magnet 12 was not present in the FIG. 2 apparatus, the movable element 2 would be normally urged to move either left or right out of the central opening 15 in the core 1. With the spring magnet 12 in place, the movable element 2 has a rest position as shown in FIG. 2.

The spring magnet 12 can also function to provide the linear electrical machine 10 with a positive spring rate so the force needed to displace the movable element 2 from the rest position increases with increasing displacement. Without the spring magnet 12 in this embodiment, the apparatus would have a negative spring rate over most of the stroke of the movable element, which may be desirable in some applications, but is generally not desirable when the linear electrical machine 10 is used in power generation. The spring magnet 12 cross-section dimensions and magnetic material properties can be adjusted to achieve a nominally constant spring rate over the operating displacement range of the movable element 2 with optional augmentation of the rate near the central position. This feature may be desirable in power generation applications, for example where the moving field element is driven by the piston of a free piston Stirling engine. Here the magnetic spring rate in concert with a pneumatically developed component acts with the total mass of the moving elements (electrical machine and prime mover) to achieve the desired mechanically resonant operation of the electrical machine and prime mover system. Additionally the positive magnetic spring rate, optionally augmented in the vicinity of zero displacement by adjustment of the spring magnet 12 cross-section dimensions and magnetic material properties, provides means to assure that the mean piston position does not drift from a desired fixed station.

The spring magnet 12 may also function to move a portion of the power source 20 (as well as the movable element 2) when the system is inactive. For example, if the power source 20 includes a free piston Stirling engine, the force of the spring magnet 12 may cause a piston of the Stirling engine to move to a known central position that allows easier start up of the Stirling engine. In this regard, the linear electrical machine 10 may be briefly driven by an electrical current applied to the coil 3 so the linear electrical machine acts as a linear motor to move the Stirling engine piston during start up.

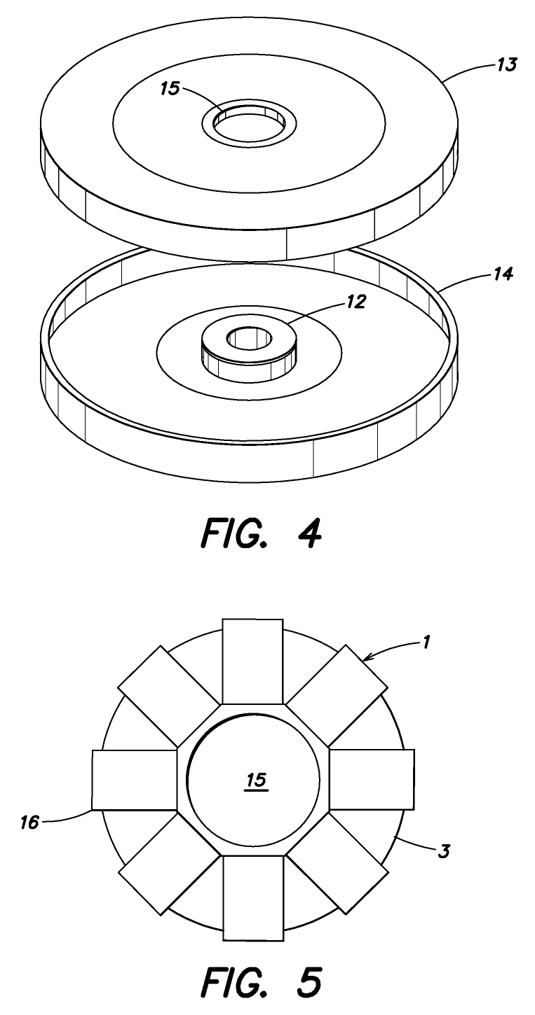

FIG. 4 shows a perspective view of a core 1 in an illustrative embodiment. In one aspect of the invention, the core 1 may be made in a split arrangement having two halves 13 and 14. In this way, the coil 3, after being pre-wound on a split bobbin fixture and mechanically stabilized by chemical or thermal fusing of a bonding coat applied to the wire or by impregnation with a bonding agent such as electrical grade varnish or epoxy resin, may be inserted into the cavity (after removal of the split bobbin winding fixture) between the two halves 13 and 14. The halves 13 and 14 may then be assembled in a clam-shell type arrangement to at least partially surround the coil with core material. The spring magnet 12, which may have an annular shape, may also be inserted between the core halves 13 and 14 in the gap (FIG. 2, 11) near the central opening 15. The cores may be provided with piloting details on the inner or outer rims to assure their concentric alignment. As a final assembly step an encapsulant may be injected to fill voids between coil turns and between the coil and the core cavity. The encapsulant bridging these voids may also serve to facilitate transfer of coil heat dissipation to the core and in turn to the housing in which the core is mounted. The encapsulant may also serve to permanently secure the coil, optional spring magnet and core halves.

In another aspect of the invention, the core 1 may be made from a coated, magnetically soft, ferromagnetic powder metal material that is pressed and bonded together in the net or near net shape of the core. Although the specific types of material may vary, in one embodiment, the powder metal material includes small particles of soft magnetic material each surrounded by a layer of electrically insulating material, such as an insulating plastic. The particles may be joined together by forming the particles into the desired shape, and then heating and pressing the particles together so the insulating layers on adjacent particles bond together. The resulting structure has favorable magnetic properties for this application, i.e., high permeability, high saturation flux density and low hysteretic loss, but is highly resistant to eddy currents flowing through the structure and consequent losses due to the flow of such currents. Such powder metal forming techniques are described, for example, in U.S. Pat. No. 6,342,108. An illustrative powder material is Atomet EM-1 Ferromagnetic Composite powder manufactured by Quebec Metal Powders.

The core 1 is not limited to forming by powder metal techniques, but instead may be formed by other methods. For example, FIG. 5 shows a core 1 in an illustrative embodiment that has an array of rectangular or quasi-rectangular lamination packs 16 arranged in an annular ring. These lamination packs 16 may have a cross-section that resembles the cross-section of the core 1 shown in FIG. 2. Lamination packs used to form a magnetic core are well known in the art and typically have thin layers of magnetically soft (readily magnetizable) material stacked together with insulating material between adjacent layers so the flow of eddy currents between layers is resisted. FIG. 5 also shows the coil 3 extending around the central opening 15 and through the lamination packs 16. The individual packs may be split in two sections after the fashion of the previously described cores of FIG. 4 so as to facilitate assembly with a pre-wound coil. In this embodiment, the coil 3 is only partially surrounded by core material which is sufficient since the flux density in the radial core legs is nominally uniform and no greater at the outer extent of these legs than at the innermost station. However, it is possible to form each of the lamination packs 16 in a type of wedge shape so the coil 3 is more completely surrounded which may offer the advantage of providing a more robust core structure albeit at substantially greater expense required for the forming of laminations of tapered thickness. In addition, the faces of the lamination packs 16 near the central opening 15 may be curved or otherwise shaped to closely conform and maintain a uniform gap with the magnets in the movable element 2. For example, if the magnets in the movable element are annular as shown in FIG. 1, the inner faces of the lamination packs 16 may be curved to form a circular central opening 15. If the magnets have another shape, such as an octagonal cross-section, the inner faces of the lamination packs 16 may have an octagonal shape as shown in FIG. 5. In such a case, a spline or other mechanical means may be provided to inhibit rotation of the moving magnet field element.

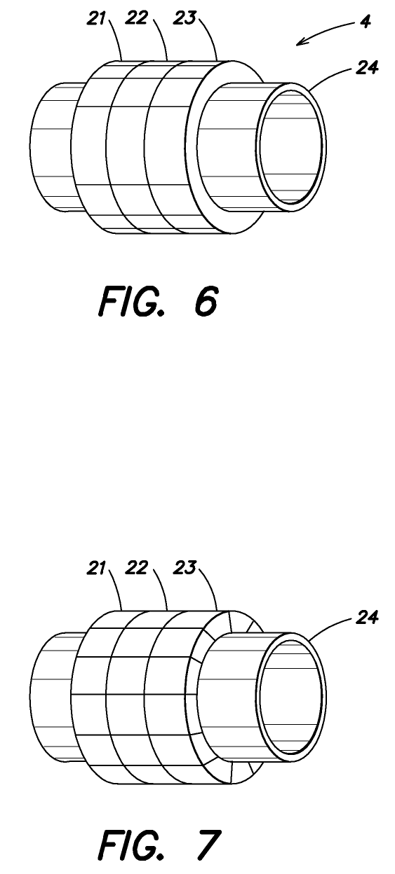

FIG. 6 shows a perspective view of a movable element 4 in an illustrative embodiment. In this embodiment, the magnets 21, 22 and 23 have an annular shape and are mounted on a back iron element 24, e.g., a sleeve of magnetically soft material. The magnets 21, 22 and 23 may be secured to the back iron sleeve 24 in any suitable way, such as by adhesive or other bonding or be closely fitted, but unsecured, to the sleeve and retained by compressive force applied by non-magnetic collars, one of which may be bonded, e.g., brazed, to the sleeve at one end and the other held in place on the opposite end by a screw thread connection with the sleeve. The nominally axially magnetized side magnets 21 and 23 may be made of any suitable material and process to form a permanent magnet ring of such magnetization orientation, such as Hitachi grade HS-34DV sintered neodymium iron boron material. Radially magnetized center magnet 22 and the spring magnet 12 may be made of any suitable material and process to form a permanent magnet ring of such magnetization orientation, such as Hitachi grade HS-33DR sintered neodymium iron boron material. Alternatively, lower cost, lower performance and bonded neodymium iron boron magnet rings may be used.

In addition, the magnets 21, 22 and 23 are not limited to the annular arrangement shown in FIG. 6. For example, FIG. 7 shows another illustrative embodiment in which the magnets 21, 22, and 23 are assembled from magnet segments arranged on the back iron sleeve 24. The magnet segments may be joined together in any suitable way, such as by adhesive, a circumferential band around the outside surface of the magnet segments, etc. As discussed above, other magnet arrangements are also possible where the magnets present a cross-sectional shape different from the circular shape shown in FIGS. 5 and 6. For example, the magnets may be shaped to form a triangle, square, hexagon, or any other suitable polygonal shape. In such cases, the core 1 would typically be shaped to closely conform to at least a portion of the shape of the magnets and mechanical means may be provided to inhibit rotation of the moving field element about the longitudinal axis. Although in these embodiments, the magnets 21, 22 and 23 are hollow, i.e., have some void formed in the magnets, the magnets may be made solid. However, solid magnets are not necessarily required to provide suitable operating characteristics.

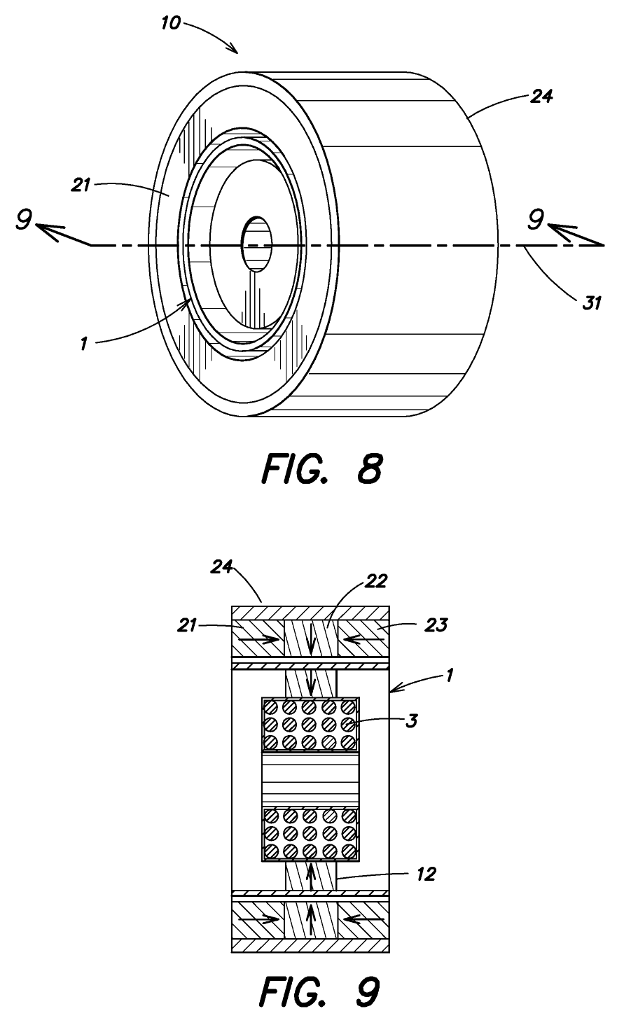

Although various embodiments are described above in which a movable element carries magnets that move relative to a core-coil assembly, it is also possible that the core-coil assembly be moved relative to the magnets. Further, the core-coil assembly may be positioned within the magnets in an arrangement opposite to that shown in FIG. 1. For example, FIG. 8 shows a linear electrical machine 10 that has a core-coil assembly 1 positioned inside of an annular magnet array along a longitudinal axis 31. FIG. 9 shows a cross-sectional view of the machine 10 along the line 9-9 in FIG. 8. The operation of this illustrative embodiment is similar to that in FIGS. 1 and 2, except that the annular magnets 21, 22 and 23 in FIGS. 8 and 9 are external to the core 1 and coil 3. Thus, as the magnets 21, 22 and 23 move along the longitudinal axis 31 relative to the core 1 and the coil 3, a current may be induced in the coil 3 (or a current in the coil 3 may cause the movable element 2 to move). The same configuration of FIGS. 8 and 9 may also be arranged so that the core 1 and coil 3 move along the longitudinal axis 31 relative to the magnets 21, 22 and 23.

In another embodiment, two or more linear electrical machines may be ganged together in series or parallel to increase the total power capability of the resulting combination. Thus, a single movable element may include two or more sets of three magnets with each set of magnets having the arrangement shown in FIG. 2. Each of the magnet sets may cooperate with a corresponding core-coil armature assembly to generate electric power or be driven by a magnetic flux created by the coil and core.

Although aspects of the invention are not limited to any particular embodiment described, one embodiment found to be particularly effective for use with a Stirling engine power source has a configuration like that shown in FIGS. 1 and 2. In this embodiment, the core 1 has an overall diameter of approximately 6 to 24 cm, a width along the longitudinal axis 31 of approximately 2.5 to 10 cm, and a diameter at the central opening 15 of approximately 2 to 8 cm. The magnets 21, 22 and 23 are annular rings and have an overall diameter of approximately 2 to 8 cm, a length l of approximately one third that of the peak displacement of the moving field element and a radial thickness of approximately 0.6 to 1.0 times the length l. The left or right displacement of the movable element 2 may be limited to less than the length l of the magnets 21, 22 and 23, e.g., 0.8 cm. Said another way, the total stroke length of the movable element 2 may be less than twice the length l of each of the magnets 21, 22 or 23. The core is made of a sintered powder material and has a clam-shell arrangement, as discussed above. A spring magnet 12 is provided with the core 1 and is made in a way similar to the center magnet 22. The magnets are made of a sintered neodymium iron boron material, as discussed above, having an energy product of at least 30 MGOe. The radially magnetized magnets 22 and 12 are made by the process described above available from Hitachi USA, or a similar process for providing annular, radially magnetized magnets of sintered neodymium iron boron material. The magnets 21, 22 and 23 are made as a single piece annular ring, i.e., are not segmented, and are mounted on a soft magnetic back iron sleeve. Other proportional sizes of the device are nominally those shown in FIG. 2, although the drawings are not to scale.

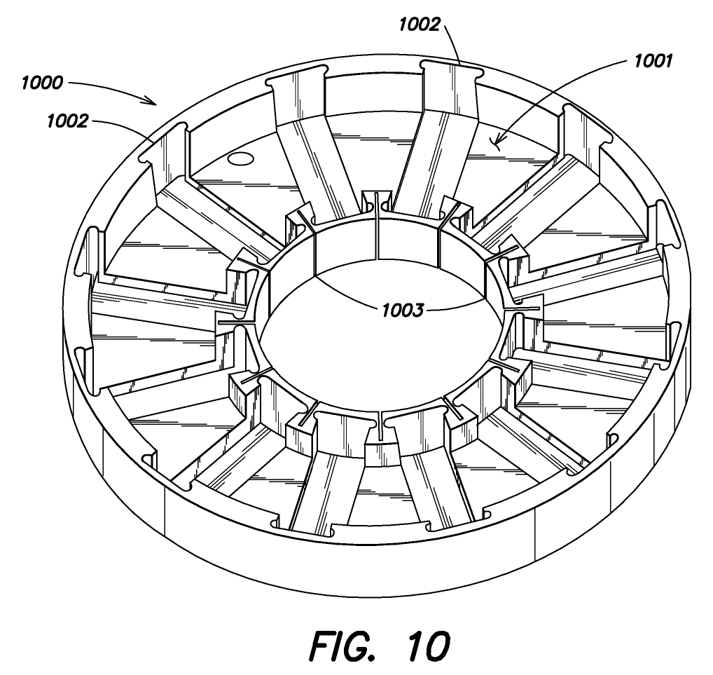

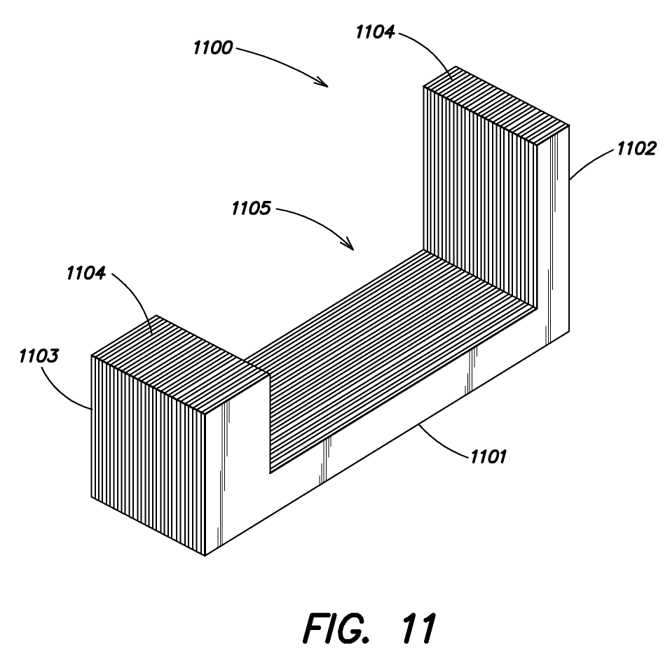

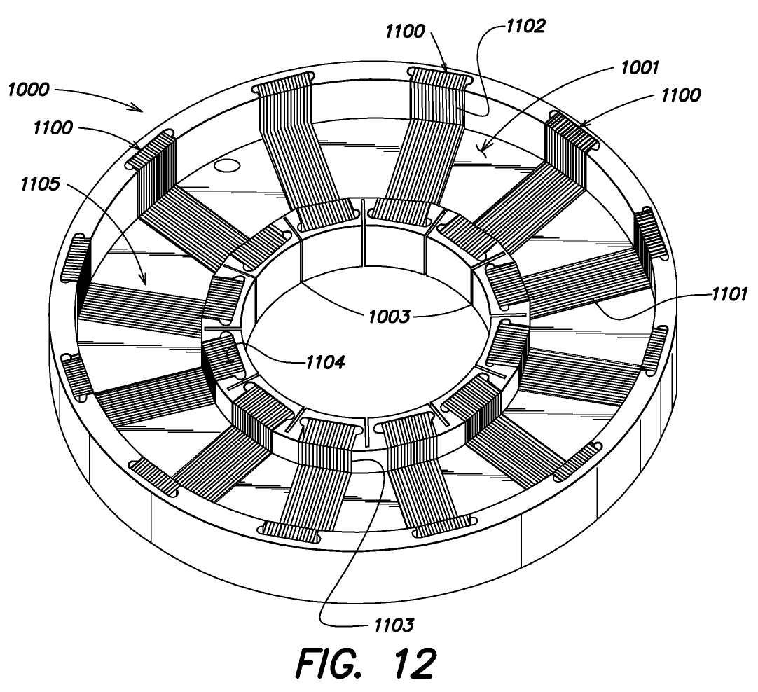

A hybrid core embodiment illustrating some aspects of the present invention is now described in connection with FIGS. 10, 11 and 12. The hybrid core of this embodiment includes a shell 1000 of a ferromagnetic composite material as shown in FIG. 10 and one or more core lamination stacks 1100 as shown in FIG. 11. The assembled core is shown in FIG. 12.

The composite of which the core shell is composed preferably includes a ferromagnetic powder mixed with an organic or inorganic binding agent having favorable thermal and other physical and mechanical properties. A core shell formed by pressing such a powder into a mold has been found to possess high dimensional stability, a useful permeability and good thermal conductivity—all desirable properties for the core of an electric machine such as a motor or generator.

Materials which are suitable are commercially available from several sources. These sources include Quebec Metal Powders of Canada, who make several Ferro-Magnetic Composite (FMC) materials under the ATOMET trade name; Höganäs of Sweden, who make a material called soft magnetic composite materials under the SOMALOY trade name; and, Hoeganaes of the United States, who make a similar “soft” magnetic material. A suitable generic material is pure iron powder, coated with plastic, and of sufficiently small particle size to provide the desired magnetic, mechanical, thermal and other physical properties.

Desired materials should have “good” ferromagnetic properties for use in electrical machinery, meaning they are magnetically soft enough to efficiently direct magnetic flux where desired with a relatively small driving magneto-motive force (mmf). Such materials should be capable, for example, of supporting flux densities of 1.5 T or greater. Desired materials should also be able to be compacted or formed into shaped parts with three-dimensional features, i.e., parts having complex shapes. Moreover, they should possess low hysteretic and eddy current losses when compacted into shaped core parts which support a time varying magnetic flux, which may vary in one or both of amplitude and direction.

Lamination stacks 1100 are preferably formed of motor lamination steel having superior magnetic property qualities relative to the core shell composite material. They should be capable of supporting at least 1.8 T flux densities with very low mmf while incurring relatively low eddy current and hysteretic losses. Lamination stacks of the exemplary embodiment are generally c-shaped, as shown in FIG. 11, having a long back bar 1101 and two shorter arms 1102, 1103.

Although grain oriented lamination steel, often used for wound transformer and inductor cores, with grain oriented along the long back bar 1101 of the lamination stack 1100, can be used, non-oriented steel is preferred. Non-oriented lamination steel is preferred because flux lines entering the lamination edge 1104 perpendicular to or at least oblique to the orientation direction may result in greater eddy current losses than flux lines entering the edge of non-oriented steel. Grain oriented lamination steel, oriented along edges 1102 and 1103 might be advantageously used to reduce eddy current and hysteretic losses provided the breadth of the back bar portion 1101 is such that the flux density and consequent losses in this section are relatively small.

In the exemplary embodiment, the core shell 1000 is a ring having plural cavities therein. A toroidal cavity 1001 is present to receive a coil (not shown). Radial recesses 1002, regularly spaced about the toroidal cavity 1001, are present to receive the c-shaped lamination stacks 1100. When received in the core shell 1000, the toroidal cavity 1001 of the core shell 1000 and the opening 1105 of the c-shaped lamination stacks 1100 between the arms 1102, 1103, of the “C” form a generally smooth-walled toroidal space in which to receive the coil.

Two such core shells 1000 are assembled about a coil, as previously described herein. A spring magnet is disposed in a ring aligned with the inner ends 1104 of the c-shaped lamination stacks 1100. To reduce eddy current losses in the spring magnet, it may optionally be segmented after assembly. Slots 1003 can be optionally provided in the core shells 1000 to permit access for such segmentation.

In an alternative embodiment, using suitable materials, similar results can be obtained using injection moldable materials. Other suitable materials may include composites having favorable thermal and other physical and mechanical properties without also possessing particular magnetic properties, for example glass-filled nylon or glass-filled epoxy composites. In this case, the non-magnetically active portion of the core shell composite may occupy a greater volume of the core shell composite, making such a core somewhat less efficient, but still usable.

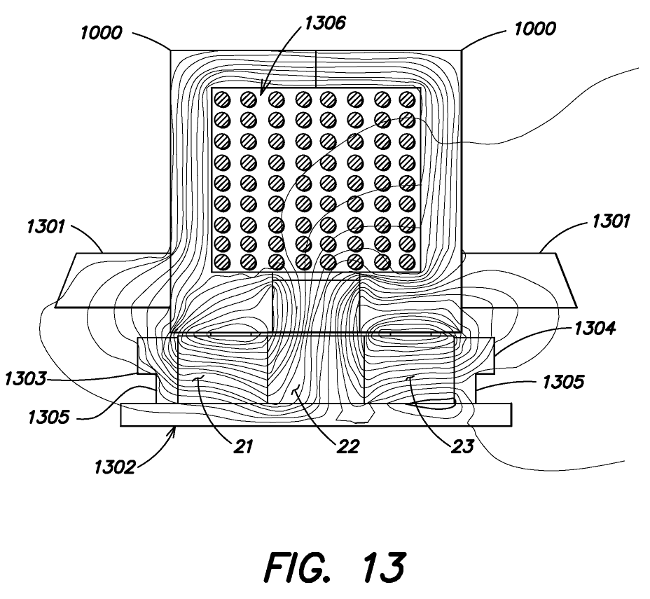

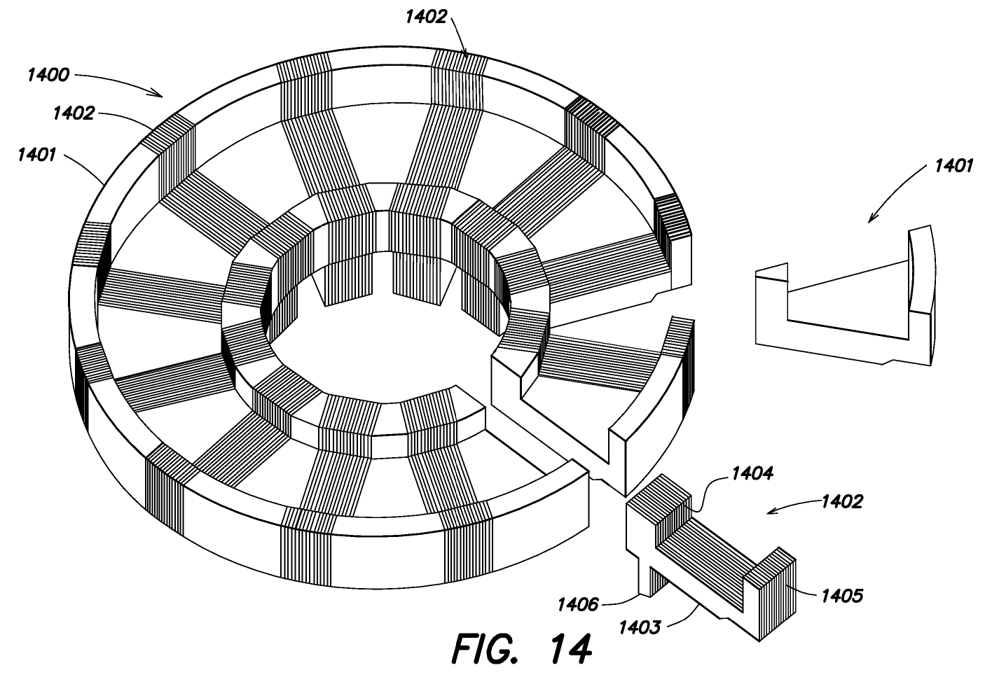

A core shield 1301 according to aspects of the invention, shown in FIG. 13, serves to reduce eddy currents and consequent eddy current losses in adjacent conductive structures such as the alternator housing or the device to which the magnet assembly is attached, such as the oscillating piston. The inner diameter of the core shield should be greater than the inner diameter of a core cavity which receives moving magnets 21, 22, and 23 by an amount augmented by approximately one half of the axial length of the moving magnets 21, 22, and 23, or such other amount effective to avoid unnecessarily reducing the magnet flux linkage with the armature coil, and thus reducing the efficiency of the machine. The core shield should preferably extend a distance in the axial direction approximately equal to the stroke length of the movable element, or such other extent suitable to a particular design.

Finally, the movable element 1302 of an electric machine may have a generally circular cross-section, for example, to fit the core comprised of two shells 1000 just described. A segment of such an element 1302 is seen in cross-section in FIG. 13. The portion of the movable element closest the core gap is thickened to form left and right end rings (1303 and 1304 in FIG. 13) that improve the efficiency of the machine by improving the flux linkage of the exemplary movable element 1302 with the armature coil 1306. The portion 1305 of the movable element farthest from the core gap may have a thinner cross-sectional area than the left and right end rings 1303, 1304 to minimize the mass of the movable element.

An alternate embodiment of aspects of the present invention, showing also how some features may be combined in practice, is illustrated in FIG. 14. A hybrid core 1400 includes alternating segments of two differing constructions 1401 and 1402.

Segments 1401 are wedge-shaped segments having a generally C-shaped cross-section within which coil wires may be received. Each segment 1401 may be composed of a ferromagnetic powder mixed with an organic or inorganic binding agent having favorable thermal and other physical and mechanical properties. Other suitable materials may include composites having favorable thermal and other physical and mechanical properties without also possessing particular magnetic properties, for example glass-filled nylon or glass-filled epoxy composites.

Segments 1402 are lamination stacks similar to those shown and described above in connection with FIG. 11. Lamination stacks 1402, like those of FIG. 11, are preferably formed of motor lamination steel having superior magnetic property qualities relative to the core shell composite material. They should be capable of supporting at least 1.8 T flux densities with very low mmf while incurring relatively low eddy current and hysteretic losses. Other physical, electrical and magnetic properties suitable for the lamination stacks shown in FIG. 11 are also suitable for lamination stacks 1402 of this embodiment. Lamination stacks 1402 of this embodiment are generally c-shaped, having a long back bar 1403 and two shorter arms 1404, 1405. In addition, lamination stacks 1402 of this embodiment also have a protruding feature 1406, forming a core shield similar to that shown in FIG. 13 (core shield 1301). Segments 1401 can optionally include a feature similar to 1406 (not shown) completing a core shield ring similar to the configuration contemplated and described in connection with FIG. 13.

Having thus described several aspects of at least one embodiment of this invention, it is to be appreciated various alterations, modifications, and improvements will readily occur to those skilled in the art. For example, the embodiments of the linear electric machine described above are fully scalable. That is, although the drawings are not precisely to scale, the overall size of the linear electric machine may be adjusted between a wide range of values (e.g., the core having a diameter of 2 cm or less up to 24 cm, as described above, or even up to 50 cm or more as may be desired) with the proportional dimensions of the various parts of the machine remaining approximately that shown in FIGS. 1 and 2. However, the proportional sizes of the parts of the machine may also be adjusted in accordance with some aspects of the invention. Such alterations, modifications, and improvements are intended to be part of this disclosure, and are intended to be within the spirit and scope of the invention. Accordingly, the foregoing description and drawings are by way of example only.

What is claimed is:

1. A hybrid core for an electric machine, comprising:
a plurality of ferromagnetic core elements; and
a support structure composed of a composite material defining plural spaces, each for receiving one of the plurality of core elements.

2. The core of claim 1, wherein the ferromagnetic core elements each comprise:
a core lamination stack including plural layers of a high permeability soft ferromagnetic sheet material.

3. The core of claim 1, wherein the support structure further comprises:
a shell defining the plural spaces and further defining together with the core elements a cavity for receiving a coil.

4. The core of claim 1, wherein the composite material further comprises:
a high permeability soft ferromagnetic material.

5. The core of claim 1, wherein the composite material further comprises:
a filled resin having high thermal conductivity and strength.

6. The core of claim 5, wherein the filled resin comprises glass-filled nylon.

7. The core of claim 5, wherein the filled resin comprises glass-filled epoxy.

8. The core of claim 1, wherein the support structure further comprises:
a plurality of generally wedge-shaped segments defining the plural spaces between faces of adjacent core elements and further defining together with the core elements a cavity for receiving a coil.

9. The core of claim 8, wherein the composite material further comprises:
a high permeability soft ferromagnetic material.

10. The core of claim 8, wherein the composite material further comprises:
a filled resin having high thermal conductivity and strength

11. The core of claim 10, wherein the filled resin comprises a glass-filled nylon.

12. The core of claim 10, wherein the filled resin comprises a glass-filled epoxy.

13. The core of claim 1, further comprising:
a core shield disposed on the support structure substantially following a perimeter of the support structure defining an opening through which a reciprocating element can pass.

14. The core of claim 1, further comprising:
a reciprocating element passing through the opening ferromagnetic frame supporting at least one magnet, there being a clearance gap between the machine core and the reciprocating element, the frame using a thicker section adjacent to the gap, so as to desirably increase magnetic flux linkage with an armature coil supported within a cavity defined by the support structure.

15. A core for an electric machine, comprising:
a ferromagnetic shell having a first cavity defined therein for receiving a coil, and having a second cavity defined therein by a perimeter and through which a moving element can pass; and
a core shield disposed on the shell substantially following the perimeter of the second cavity and displaced on the shell away from the second cavity.

16. A movable element for an electric machine, comprising:
a reciprocating element including a low reluctance ferromagnetic frame supporting at least one magnet for reciprocation within a cavity formed in a machine core, there being a clearance gap between the machine core and the reciprocating element, the frame having a thicker section adjacent the gap, so as to desirably increase magnet flux linkage with an armature coil.
